(19) United States
(12) Patent Application Publication
(10) Pub. No.: US 2018/0345052 A1
(43) Pub. Date: Dec. 6, 2018

(54) HARNESS EQUIPPED WITH ERGONOMIC CONNECTION POINTS

(71) Applicant: ZEDEL, Crolles (FR)

(72) Inventor: Benoît BOUQUIER, Corenc (FR)

(73) Assignee: ZEDEL, Crolles (FR)

(21) Appl. No.: 16/102,363

(22) Filed: Aug. 13, 2018

Related U.S. Application Data
(63) Continuation of application No. 15/705,778, filed on Sep. 15, 2017, now abandoned.

(30) Foreign Application Priority Data
Sep. 15, 2016 (FR) 1658612

(51) Int. Cl. A62B 35/00; A41F 9/00

(52) U.S. Cl. CPC A62B 35/0006; A41F 9/005; A62B 35/0012; A62B 35/0037

(57) ABSTRACT

Harness composed of textiles straps, and having at least one connection and securing point in the form of a closed loop made from textile material delineating an opening for the passage of a connector. The opening of the textile loop is strengthened by a rigid or semi-rigid insert, which is configured to facilitate fitting of a connector, and comprising a base surface securedly attached to the support structure of the harness to transmit and distribute the forces when the user is in the securing position at work. The insert comprises a shell made from plastic material having an inner hole, and guide means for running of the textile loop when the latter is wound inside the shell.

### CROSS REFERENCE TO RELATED APPLICATION

This application is a continuation of U.S. application Ser. No. 15/705,778, filed Sep. 15, 2017, which claims priority of French Application No. 1658612, filed Sep. 15, 2016, the contents of which are incorporated herein by reference.

### FIELD OF THE INVENTION

The invention relates to a harness comprising textile straps and having at least one connection and securing point in the form of a closed loop made from textile material delineating an opening for the passage of a karabiner or other connector. Such a harness is used for safety of persons when working at height.

### STATE OF THE ART

Most harnesses for working at height, in addition to the central roping hasp, comprise lateral connection points for securing and retaining when the lateral points are used in a working position of the user.

These connection points are achieved in known manner:

either by strap loops arranged on the belt strap. These loops are light, not prominent, and allow a good orientation of the connectors of the securing lanyard when working. These strap loops do on the other hand have the drawback of being less ergonomic to connect on account of their flexibility, and of presenting a deformable and small opening which complicates fitting of the connectors. Frequent use is furthermore liable to cause premature wear of the belt strap.

or by metal blocks each fitted in a loop sewn onto the belt strap. The advantage of these metal blocks of rigid structure is to be easy to connect, as the opening is large and not deformable. But the drawback of such a block is that it is prominent and liable to catch on external elements, that it is heavier, and that it orients the connectors of the securing lanyard in a direction perpendicular to the belt. Such an orientation of the connectors is not ideal for offset securing positions when working. Furthermore, the engagement of the metal blocks on the user's hips may give rise to an inconvenient compression point, to the detriment of user comfort.

Document CH695542 relates to a sit harness for mountain climbing having a belt connected to a pair of leg loops, and a central roping hasp connecting the two leg loops and having the shape of an arc. The hasp is protected by a wear resistant part made from thermoplastic or fibre-based composite material.

### OBJECT OF THE INVENTION

The object of the invention consists in remedying the above-mentioned drawbacks, and in providing a safety harness for working at height, having functional and ergonomic connection points that are easy to connect, while at the same time improving user comfort when working.

The harness according to the invention is characterized in that the opening of the textile loop is strengthened by a rigid or semi-rigid insert, which is configured to facilitate fitting of the connector, said insert comprising a base surface securedly united to the support structure of the harness to transmit and distribute the forces when the user is in the securing position at work.

According to a preferential embodiment, the insert comprises a shell made from plastic material having an inner hole adaptable to the opening of the textile loop, and guide means for running of the textile loop when the latter is wound inside the shell.

According to one feature of the invention, the base surface of the assembly formed by the shell and loop is sewn onto the support structure of the harness.

According to one feature of the invention, the loop of the connection point is arranged on the lateral and/or rear part of the belt strap.

Preferably, the loop is manufactured in continuity with an intermediate part of the belt strap. The fact that the strap runs inside the shell of the insert contributes to the connection being made inside the belt strap.

The insert presents an Omega shape, with a base surface on which a hoop is fitted to form said inner securing hole, said base being sewn onto the padding strip by seams.

The belt strap advantageously comprises at least two lateral connection points situated on each side of the central roping point, the assembly being configured to distribute the securing tension over the whole height of the harness.

According to an alternative embodiment, the loop of the connection point can be manufactured with an auxiliary strap that is distinct from the main belt strap.

The shell of the insert comprises a base surface configured to constitute a lateral, or ventral or sternal attachment point.

This strengthening function of the connection loops by the shell of the insert can be implemented in any type of safety harness for working at height.

The invention thus applies to a sit harness with or without a chest harness, and also to a simple belt for securing a user when working, without a sit harness and without a chest harness.

### BRIEF DESCRIPTION OF THE DRAWINGS

Other advantages and features will become more clearly apparent from the following description of an embodiment of the invention given for non-restrictive example purposes only and represented in the appended drawings, in which:

FIG. 1 is a perspective view of a use of the securing harness when working along a pylon;

FIG. 2 shows a partial view on an enlarged scale of the harness of FIG. 1, illustrating connection of a connector to a lateral connection point according to the invention;

FIG. 3 represents a view from the rear in the spread position of the belt equipped with two lateral connection points;

FIG. 4 is a perspective view of a connection point formed by a textile loop strengthened by an insert made from plastic material;

FIG. 5 is a cross-sectional view of the connection point of FIG. 4, fitted on the padding strip of the belt;

FIG. 6 shows a plane view of FIG. 5, illustrating the distribution of the securing and retaining tension on the belt;

FIG. 7 is a plane view of an alternative embodiment of the connection point;

FIG. 8 represents a side view of FIG. 7.

### DESCRIPTION OF A PARTICULAR EMBODIMENT

With reference to the figures, a safety harness 10 for work at height is achieved by criss-crossing of textile straps, comprising a belt 11 surrounding the user's waist, and a pair of leg loops 12. The belt 11 comprises a flexible padding strip 13, for example made from foam, on which a high-strength belt strap 14 is sewn to ensure mechanical strength for the belt 11. The belt strap 14 is narrower than the flexible padding strip 13 and is provided at the front with an openable fixing loop 15 designed to open and close the front of the belt 11. The belt strap 14 is connected to the leg loops 12 by a connecting ring able to be associated with a hasp constituting a central roping point.

The belt strap 14 further comprises at least one additional connection and securing point 16, which is laterally offset with respect to the central roping point and to the openable fixing loop 15. This additional connection and securing point 16 is in the form of a closed loop 17 made from textile material delineating an opening 18 for the passage of a connector 19, for example a karabiner of a lanyard 20 or safety rope. The additional connection and securing point 16 is configured to support a user when necessary. The additional connection and securing point 16 is formed by a strap so as to provide a compact embodiment able to ensure a good mechanical strength and without excess weight.

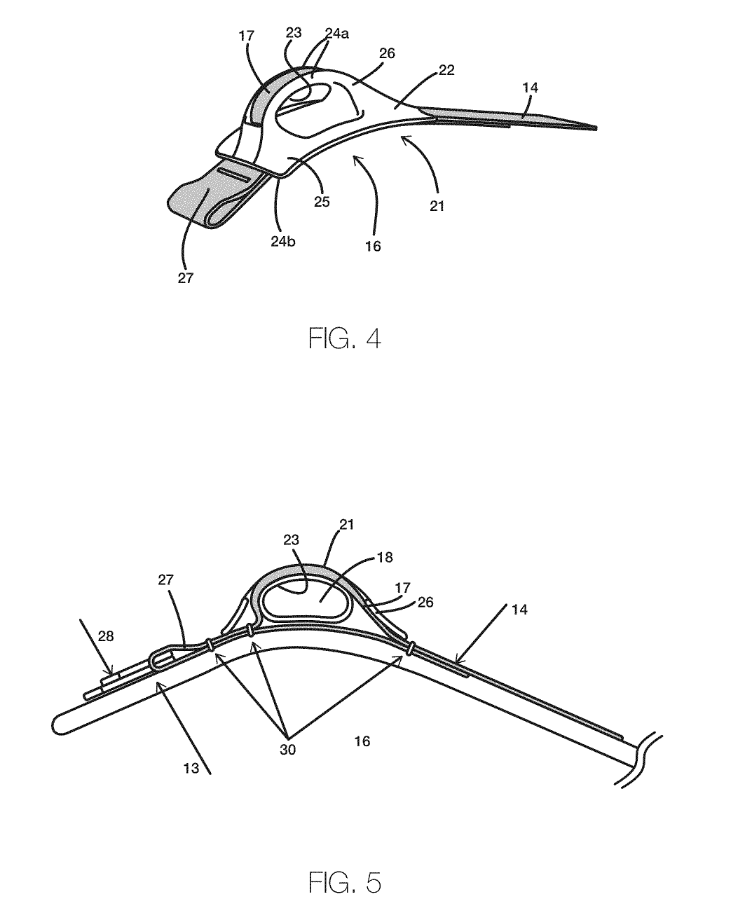

According to the invention, the opening 18 of the textile loop 17 is strengthened by a rigid or semi-rigid insert 21 (FIGS. 4 and 5), which is configured to facilitate fitting of the connector 19 and to distribute the securing tension when the user is in the working position. The insert 21 comprises for example a shell 22 made from plastic material having a non-deformable inner hole 23 adaptable to the opening 18 of the textile loop 17. The periphery of the shell 22 is provided with guide means 24a, 24b for running of the textile loop 17 when the latter is wound inside the shell 22. Preferably, this loop 17 is manufactured in continuity with an intermediate part of the belt strap 14. For example, the same strap forms the closed loop 17 and the belt strap 14 or a shoulder strap for the harness. The insert 21 ensures that the opening 18 of the textile loop 17 has at least a minimal area configured to allow insertion of the connector 19 inside the opening 18. In other words, the insert 21 is not configured to support the weight of the user when the user is only supported by the insert 21 and not by the closed loop 17. The insert may be formed in a material unable to provide enough mechanical strength and/or the fixing between the insert 21 and the support member of the harness is not configured to support the user without the strap forming the textile loop 17.

Advantageously, the insert 21 does not provide any mechanical strength when the connection and securing point 16 is under tensile strength. The mechanical strength is ensured by the textile material which defines the opening 18. The insert retransmits the forces to the textile material. The insert 21 is configured so that the textile loop does not close on itself which forces the user to use two hands to insert the connector 19 into the opening 18 and mechanically fix the connector 19 with the connection and securing point 16.

The shell 22 of the insert 21 presents a handle shape in the form of an Omega, with a slightly curved base 25, on which a hoop 26 is fitted to form said inner securing hole 23. Advantageously, the base 25 is slightly curved so as to better conform the morphology of the pelvis of the user. The shell 22 prevents the textile loop from closing on itself. In the illustrated embodiments, the textile loop is stretched or slightly stretched in order to follow the shape defined by the shell 22 of the insert 21.

Passage of the strap 14 in the insert 21 takes place in the following manner: In FIG. 4, the strap 14 is first folded on itself in the lengthwise direction to make it pass in the guide means 24a of the hoop 26. On leaving the hoop 26, it is unwound to revert to the normal width of the strap 14, and exits via the left-hand end of the base 25 to form a U-shaped turn 27. The extension of the turn 27 then passes in the opposite direction in the guide means 24b and exits via the right-hand end of the base 25. In this way, the strap 14 forms a closed loop and the insert 21 is located in the closed loop. Advantageously, the closed textile loop 17 is kept closed by any suitable means, for example by sewing.

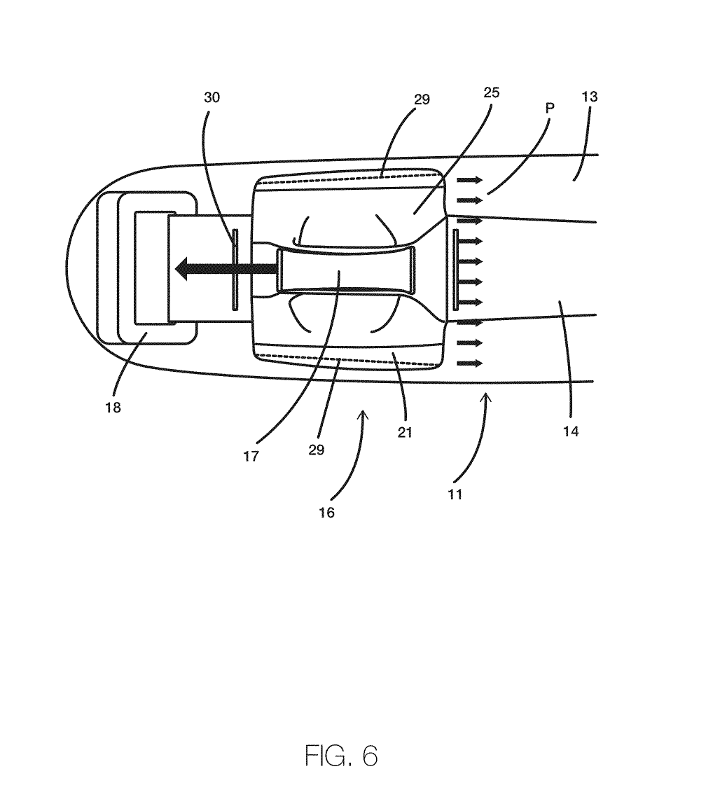

In FIGS. 5 and 6, after an additional adjustment loop 28 has been inserted in the turn 27, the assembly formed by the textile loop 17 and shell 22 of FIG. 4 is fixed onto the padding strip 13 of the belt 11 by means of different seams 29, 30 to constitute the strengthened connection point 16. In the illustrated example, the loop 27 is a terminal loop which is used to secure a device for adjusting the circumference of the strap 28, for example a device for adjusting the circumference of the belt or of a strap. The end loop may form one end of the strap

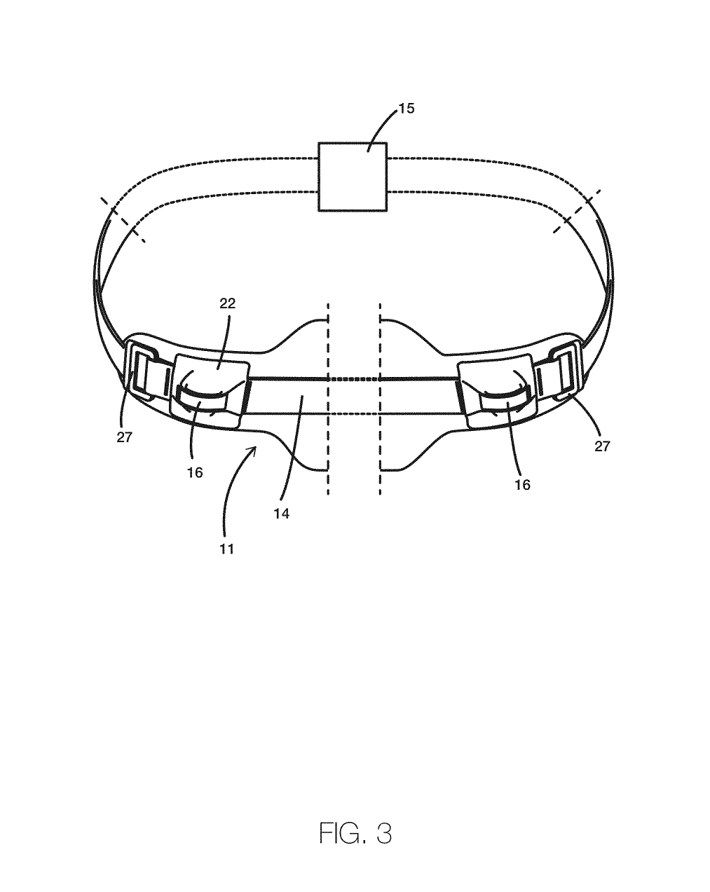

According to an embodiment of FIG. 3, the belt strap 14 comprises at least two lateral connection points 16 situated on each side of the central fixing loop 15, the assembly being configured to distribute the securing tension symmetrically over the whole height of the belt 11.

An additional connection point 16 can also be provided at the rear of the belt strap 14.

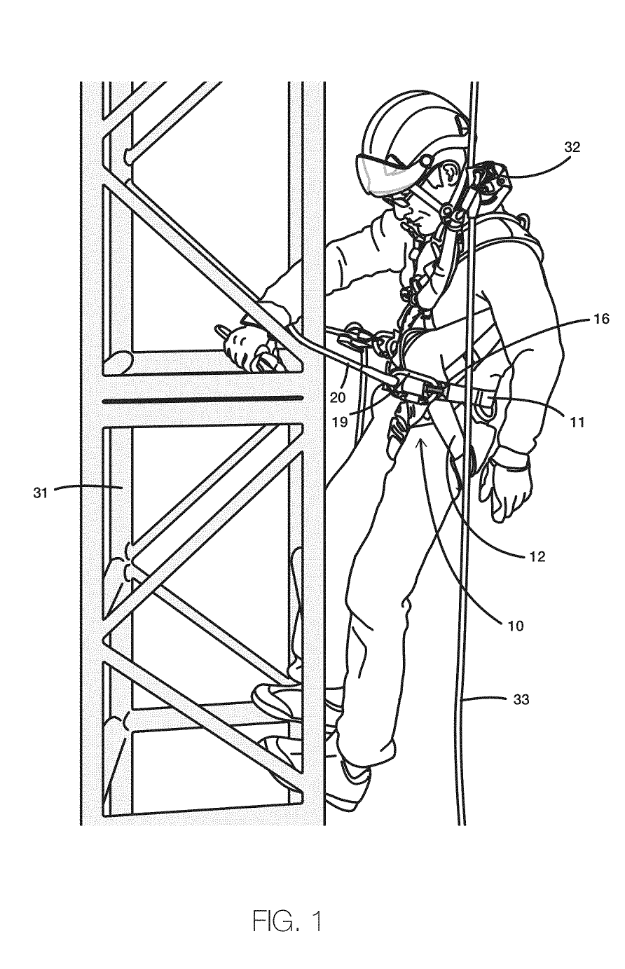

FIG. 1 shows how a user is secured when ascending along a pylon 31. He winds the safety lanyard 20 around a section of the vertical upright of the pylon 31, and attaches the two opposite ends of the lanyard 20 to the two lateral connection points 16 of the belt 11 by means of connectors 19. This results in a securing state when working which enables the user to work in total safety. A fall arrest device 32 is furthermore placed at the rear of the harness 10, and collaborates with a rope 33 to arrest any fall of the user.

In the example shown, the openings 18 are through orifices in a section plane comprising the longitudinal axis of the strap, for example the longitudinal axis of the belt. The section plane may be a horizontal plane when the user is standing. The connectors then come naturally into their working position without twisting the loop of the strap which forms the connection point. The connectors apply a force to the insert and this force is distributed over a larger surface by means of the insert 21. The comfort is improved. The surface of the opening 18 is defined by the insert which extends the textile loop so that the fixing points of the strap are always stressed in a homogeneous manner.

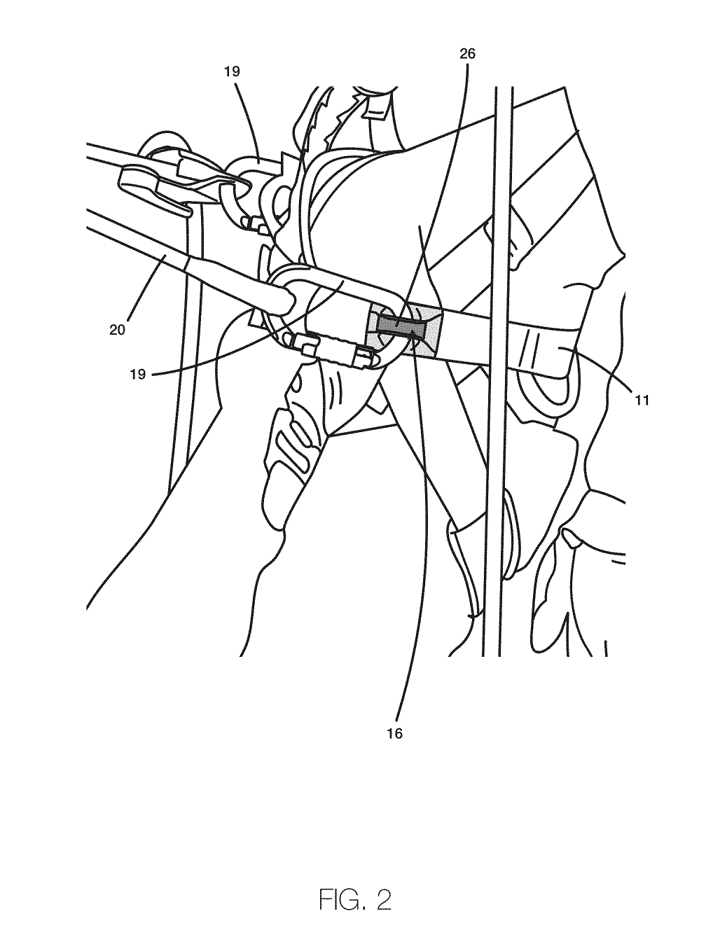

FIG. 2 illustrates an enlarged view of connection of the connector 19 of the lanyard 20. The hoop 26 of the insert 21 extends along the belt strap 14, which enables the connector 19 to place itself substantially parallel to the belt 11. The plastic shell 22 strengthens the structure of the loop 17, and maintains the opening 18 of the textile loop 17, which facilitates connection of the connector 19. The shell 22 ensures that the opening 18 has a minimal area which facilitates cooperation with a connector.

In FIG. 6, it can be observed that the width of the base 25 of the shell 22 of the connection point 16 enables the securing tension exerted by the lanyard 20 on the rear of the belt to be distributed. This distribution P of the tension is effective over the whole height of the padding strip 13, i.e. over a larger height than that of the belt strap 14. The use of these ergonomic connection points 16 ensures an optimum securing comfort when working. It is particularly advantageous to have a base 25 having a width greater than the width of the strap 14 and possibly less than the width of the padding strip. The width is measured in a direction perpendicular to the longitudinal axis of the strap, in this case in a direction perpendicular to the arrows representing the forces P.

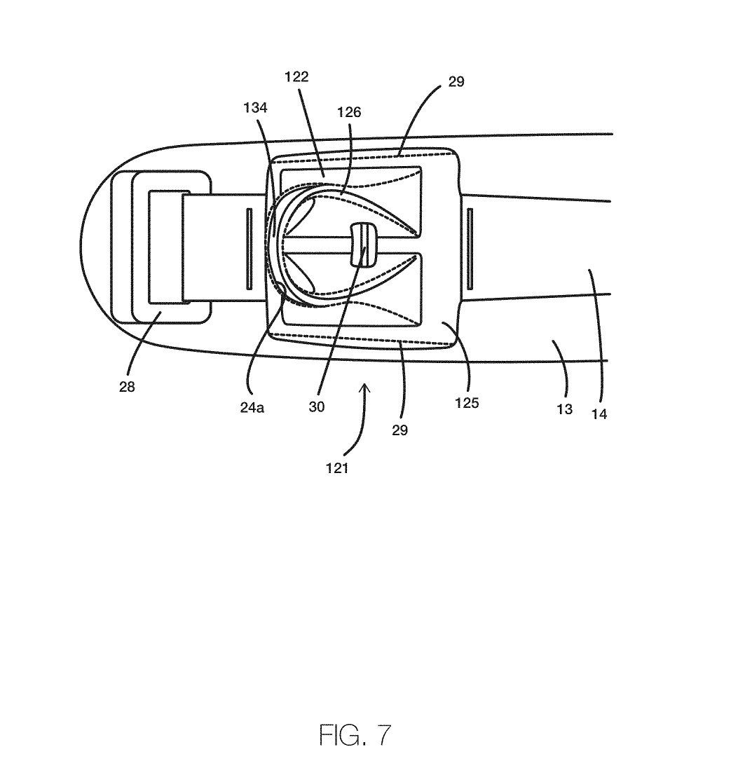

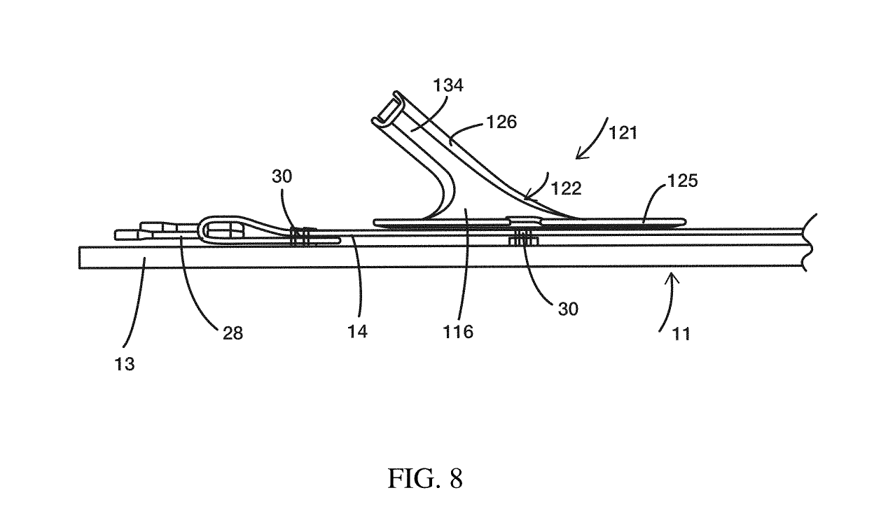

FIGS. 7 and 8 show an alternative embodiment of the connection point 116. The auxiliary strap 134 forming the loop 117 is in this case distinct from the main belt strap 14. The auxiliary strap 134 extends along the hoop 126 of the insert 121, and exits from the base 125 of the shell 122 being sewn onto the belt strap 14. The base 125 of the insert 121 is in the form of a rectangular plate which is sewn onto the padding strip 13 of the belt by seams 29. The hoop 126 is inclined to the left with respect to the base 125.

It is possible to provide strengthened connection points on any other part of the harness, in particular to form in addition lateral securing points for working, a fall arrest connection point, or auxiliary securing points, in particular ventral and sternal. The base 25, 125 of the insert 21, 121 is configured in specific manner for each of these connection points.

What is claimed is:

1. Harness comprising:
textiles straps, at least one of the textile straps defines at least one connection and securing point in the form of a closed textile loop made from textile material, said at least one connection and securing point delineating an opening for the passage of a connector,
a rigid or semi-rigid insert configured to strengthen the closed textile loop so as to facilitate fitting of the connector said rigid or semi-rigid insert comprising a base surface securedly attached to a support structure of the harness to transmit and distribute the forces when a user is in a securing position at work.

2. Harness according to claim 1, wherein the rigid or semi-rigid insert comprises a shell made from plastic material having an inner hole adaptable to the opening of the textile loop, and guide means for running of the textile loop when the textile loop is wound inside the shell.

3. Harness according to claim 1, wherein the base surface of the rigid or semi-rigid insert is sewn onto the support structure.

4. Harness according to claim 1, wherein the textile loop of the at least one connection and securing point is arranged on a belt strap and the base surface is securedly attached to the belt strap.

5. Harness according to claim 4, wherein the textile loop of the at least one connection and securing point is manufactured in continuity with an intermediate part of the belt strap.

6. Harness according to claim 4, wherein the textile loop of the at least one connection and securing point is manufactured with an auxiliary strap distinct from the belt strap, the auxiliary strap is attached to the belt strap.

7. Harness according to claim 4, wherein the textile loop of the at least one connection and securing point is positioned on a lateral part of the belt strap so as to form a lateral suspension point.

8. Harness according to claim 4, wherein the textile loop of the at least one connection and securing point is positioned on a rear part of the belt strap so as to form a dorsal suspension point.

9. Harness according to claim 7, wherein the belt strap comprises at least two lateral suspension points situated on each side of a central fixing loop, the two lateral suspension points being configured to distribute the securing tension over the whole height of the belt when the user sits on the harness.

10. Harness according to claim 9, wherein an additional connection point is arranged on a rear part of the belt strap so as to form a dorsal suspension point.

11. Harness according to claim 2, wherein the rigid or semi-rigid insert presents an Omega shape, with a base surface on which a hoop is fitted to form said inner securing hole, said base surface being sewn onto a padding strip by seams.

12. Harness according to claim 11, wherein the padding strip is formed by foam attached to the belt strap.
